(19) United States
(12) Patent Application Publication
(10) Pub. No.: US 2005/0035051 A1
(43) Pub. Date: Feb. 17, 2005

(54) Extended area filter

(75) Inventors: William R. Kelly, Prospect, CT (US); Larry Moore, Hamden, CT (US)

Correspondence Address: WILMER CUTLER PICKERING HALE AND DORR LLP, 60 STATE STREET, BOSTON, MA, 02109, US

(73) Assignee: Mott Metallurgical Corporation, Farmington, CT (US)

(21) Appl. No.: 10/639,275

(22) Filed: Aug. 12, 2003

(51) Int. Cl. B01D 35/28

(52) U.S. Cl. 210/435; 210/456; 210/502.1

(57) ABSTRACT

An extended area filter is provided that is useful in polymer melt spin pack assemblies. The filter is a uniform porous body that is made, for example, of sintered powder metal, and contains multiple opposing spaced apart inlet and outlet cavities. The filter has substantially uniform pore structure and density, and is substantially free from polymer binder decomposition products, allowing for more uniform flow with improved throughput and filtration life.

### BACKGROUND

1. Field of the Invention

The invention relates to filtration during polymer melt spinning, and in particular to porous filters for use in spin pack assemblies.

2. Description of Related Art

Synthetic polymer fibers typically are manufactured by extruding filaments of molten polymer under pressure through openings in plates called “spinnerettes,” which are contained in “spinnerette heads” in spinning units known as “spin packs.” Before extrusion through the spinnerette, the polymer melt must be filtered to remove solid contaminants and gelled polymer particles. Unless removed by filtration, such impurities can clog the spinnerette or pass through the spinnerette and cause defects in the product polymer fiber.

Various filtration systems have been used in spin packs to filter the polymer melt immediately prior to extrusion through the spinnerette. Ideally, the filtration media should retain particulate impurities and also impart shear, i.e., induce alignment and reduce cross-linking between polymer chains. Known filtration media include sand, shattered metal, metal fiber, screen packs, and porous metal discs and cups. A traditional spin pack filtration assembly includes loose filtration media, such as sand or shattered metal. The loose fill is assembled in situ at the site of polymer filtration as a layered bed confined between screens, and a sealing ring is used to seal the filtration assembly within the spin pack and prevent polymer leakage. The bed of loose fill generally includes multiple layers of particles, with each layer having progressively finer particle size. These layers create a depth filtration effect, which prolongs the life of the filter because larger contaminant particles are removed by the coarse upstream filtration layers, leaving the finer downstream filtration layers open to retain smaller contaminant particles. However, loose media do not provide optimal filtration, as they tend to migrate, separate, channel, and fluidize. Such irregular, uncontrollable motion of the particles of loose fill reduces filtration effectiveness and causes inconsistent filtration over the life of a filter and across filters. Similarly to traditional loose fill, metal fiber has a soft, weak structure that must be surrounded by screens to prevent migration under pressure. Further, metal fiber has a large open void volume, which affords great dirt holding capacity but has limited ability to impart shear.

Porous metal discs and cups have a fixed, sintered structure that provides good shear and affords controlled, consistent filtration because it is not subject to migration. However, traditional porous metal filters often have difficulty withstanding the high pressures used in polymer melt extrusion or, if they are thick enough to withstand such pressures, afford sub-optimal flow rates. Furthermore, porous metal discs and cups often suffer from reduced filtration life due to surface blinding and caking.

To reduce the pressure drop across the filter and improve filtration life, sintered metal filters having extended filter surface area have been made. Some such extended area filters include cylindrical or conical cavities defined by multiple distinct tubular filter elements (e.g., Mott, U.S. Pat. No. 3,570,059) or an integral cavity-containing structure (e.g., Bergstrom, U.S. Pat. Nos. 3,746,642 and 3,788,486). Such filters offer extended filtration area, but sometimes include a multi-component assembly (e.g., a group of cups in an adapter) that is subject to leakage between components. Furthermore, many extended area filters require a thick inter-cavity wall structure to afford sufficient strength for high-pressure applications, which adversely affects flow rate and throughput. In addition, surrounding support structure (e.g., breaker plate and screens) is often required to prevent the filter from bending, fracturing, or collapsing under pressure.

Furthermore, the production of many extended area filters is time-consuming and expensive, and some commonly used production steps cause shortcomings in the end product. For example, machining steps typically used to form the cavity structure of extended area filters often cause distortions in the pores and surface morphology of the filters, such as non-uniform density, smeared pores, and surface blinding. Such structural distortions result in reduced flow rate and consistency, and decreased filtration life. Another common production technique that causes drawbacks in the final filter product involves the use of polymeric binders. Extended area filters are often made from a dispersion of metal powder mixed with a binder. The use of such a dispersion can adversely affect the retention rating of the final filter product, e.g., due to non-uniformity of the dispersion, shear and damage to the metal particulate during mixing, and shelf life limitations of the dispersion. Moreover, the binder is later burned off from the final filter product, leaving behind polymer binder decomposition products, e.g., residual carbon, as contaminants that affect the corrosion resistance and surface chemistry of the filter.

Thus, a need remains in the art for new extended area filters, and methods of making the same, that provide controlled, consistent filtration with good flow rate and filtration life, and can be efficiently and cost-effectively manufactured, installed, serviced, and replaced.

### SUMMARY

The invention provides an extended area filter that is particularly useful in polymer melt filtration. The filter offers improved uniformity of flow, increased throughput, and extended filtration life, and is efficiently and economically produced, installed, maintained, and replaced.

Accordingly, in one aspect, the invention provides an integral (i.e., single-component) porous filter. The filter is formed of a fixed media. The media is formed to have substantially uniform pore structure and density, and is substantially free from polymer binder decomposition products. The filter has an inlet end defining a plurality of inlet openings and an outlet end defining a plurality of outlet openings. The filter defines a plurality of blind inlet cavities extending into the filter from the inlet openings in the inlet end, and a plurality of blind outlet cavities extending into the filter from the outlet openings in the outlet end. Each inlet and outlet cavity defines a fluid communication path and is closed at one end. The inlet and outlet cavities are arranged so that fluid entering an inlet cavity flows into the inlet cavity and through a wall defining the cavity into an adjacent outlet cavity.

In some embodiments, the filter is formed from compressed, sintered powder metal. In certain embodiments, the raw powder metal (before compression and sintering) has a U.S. Standard Sieve mesh size between about 12 and about 500. In particular embodiments, the powder metal has a mesh size selected from the group consisting of 30/45 mesh, 50/100 mesh, and blends thereof. In certain embodiments, the powder metal has a particle size (diameter) of about 1 μm or greater. In specific embodiments, the powder metal is selected from the group consisting of stainless steel, nickel, tungsten, copper, bronze, and combinations thereof. In certain embodiments, the powder metal includes nickel or austenitic chromium-nickel stainless steel. In some embodiments, the powder metal is water atomized. In specific embodiments, the filter has a nominal filtration rating between about 5 μm and about 110 μm, for example, about 10 μm, about 40 μm, about 60 μm, or about 100 μm. In certain embodiments, the filter has a nominal filtration rating between about 0.1 μm and about 5 μm. In particular embodiments, the filter has a particle filtration efficiency in gas applications of at least about 90% for particles having a diameter greater than about 0.1 μm.

In some embodiments, the filter is approximately cylindrical in shape and has a length to diameter ratio of about 3:1 or less. In particular embodiments, the length to diameter ratio is about 1:1 or less. In certain embodiments, the filter has a length between about 20 mm and about 50 mm, and a diameter of between about 30 mm and about 70 mm. In specific embodiments, the filter has a length between about 30 mm and about 40 mm, and a diameter of about 50 mm. In certain embodiments, the filter defines cylindrical inlet cavities and outlet cavities having substantially uniform diameter and substantially uniform wall thickness between cavities.

Another aspect of the invention provides a polymer melt spin pack assembly including a spinnerette head. The spinnerette head has a filter housing and an integral porous filter disposed within the filter housing. The filter is formed of a fixed media. The media is formed to have substantially uniform pore structure and density, and is substantially free from polymer binder decomposition products. The filter has an inlet end defining a plurality of inlet openings and an outlet end defining a plurality of outlet openings. The filter defines a plurality of blind inlet cavities extending into the filter from the inlet openings in the inlet end, and a plurality of blind outlet cavities extending into the filter from the outlet openings in the outlet end. Each inlet and outlet cavity defines a fluid communication path and is closed at one end. The inlet and outlet cavities are arranged so that fluid entering an inlet cavity flows into the inlet cavity and through a wall defining the cavity into an adjacent outlet cavity.

In some embodiments, the spinnerette head has an adapter ring for sealing the filter within the filter housing. In alternative embodiments, the filter is sealed within the filter housing by an interference fit.

Still another aspect of the invention provides a method of filtering a polymer melt for extrusion. The method includes providing a polymer melt spin pack assembly containing a spinnerette head. The spinnerette head includes a spinnerette, a filter housing, and an integral porous filter disposed within the filter housing. The filter is formed of a fixed media. The media is formed to have substantially uniform pore structure and density, and is substantially free from polymer binder decomposition products. The filter has a side wall, an inlet end defining a plurality of inlet openings, and an outlet end defining a plurality of outlet openings. The filter defines a plurality of blind inlet cavities extending into the filter from the inlet openings in the inlet end, and a plurality of blind outlet cavities extending into the filter from the outlet openings in the outlet end. Each inlet and outlet cavity defines a fluid communication path and is closed at one end. The inlet and outlet cavities are arranged so that fluid entering an inlet cavity flows into the inlet cavity and through a wall defining the cavity into an adjacent outlet cavity. The method further includes introducing a polymer melt into the filter through the inlet end and optionally the side wall of the filter. The polymer melt flows through the inlet cavities, walls defining the cavities, and outlet cavities of the filter, and filtered polymer melt flows out of the outlet end of the filter. The filtered polymer melt is extruded through the spinnerette.

### BRIEF DESCRIPTION OF THE DRAWINGS

In the Drawing,

FIG. 1A is a top view of the inlet end of a filter according to certain embodiments of the invention.

FIG. 1B is a cross-sectional view of a filter according to certain embodiments of the invention, with arrows indicating the flow of material to be filtered through the unit.

FIG. 1C is a top view of the outlet end of a filter according to certain embodiments of the invention.

FIG. 1D is an expanded view of a portion of FIG. 1B, which is a cross-sectional view of a filter according to certain embodiments of the invention, with arrows indicating the flow of material to be filtered through the unit.

FIG. 2A is a top view of the inlet end of a filter according to certain embodiments of the invention.

FIG. 2B is a cross-sectional view of a filter according to certain embodiments of the invention, fit into a media cup from a spinnerette head assembly, with arrows indicating the flow of material to be filtered through the unit.

FIG. 2C is a top view of the outlet end of a filter according to certain embodiments of the invention.

FIG. 2D is an expanded view of FIG. 2B, which is a cross-sectional view of a filter according to certain embodiments of the invention, fit into a media cup from a spinnerette head assembly, with arrows indicating the flow of material to be filtered through the unit.

FIGS. 3A-C are top views of, respectively, the top cap, filter body, and bottom cap of a filter according to certain embodiments of the invention.

FIGS. 3D-F are cross-sectional views illustrating three possible methods of assembling a filter according to certain embodiments of the invention.

### DETAILED DESCRIPTION

In certain embodiments, the invention provides an extended area filter and methods of making the same. A particularly useful application of the filter is in polymer melt spin pack assemblies for polymer melt filtration. The filter is a uniform porous body that is made, for example, of sintered powder metal, and contains multiple opposing spaced apart inlet and outlet cavities. The filter has a strong integral structure that provides good performance under high-pressure operating conditions. The filter has substantially uniform pore structure and density, and is substantially free from polymer binder decomposition products, allowing for more uniform flow with improved throughput and filtration life. The single-unit filter is easily fitted within a variety of standard spinnerette head assemblies using, for example, an adapter ring or an interference fit. The filter is made using processes that not only produce an improved filter, but also improve manufacturing efficiency and reduce manufacturing costs by eliminating traditionally employed polymer binders and secondary machining steps.

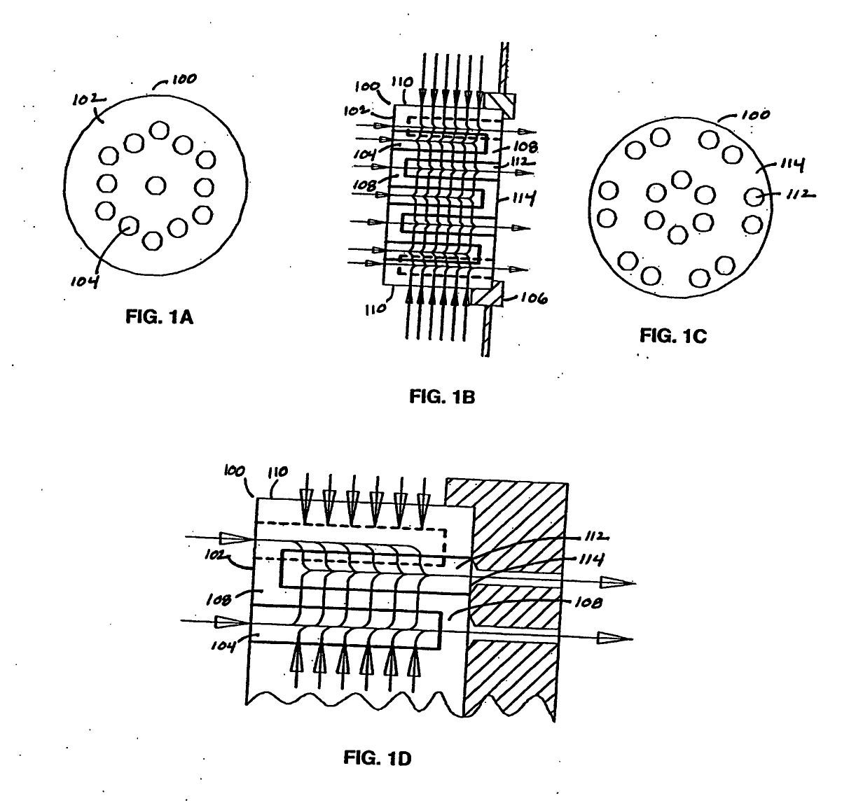

FIGS. 1A-D illustrate a filter 100 according to certain embodiments of the invention.

FIG. 1A is a top view of the inlet end 102 of the filter 100. FIG. 1B is a cross-sectional view of the filter 100 mounted in a spinnerette head assembly. FIG. 1C is a top view of the outlet end 114 of the filter 100. FIG. 1D is a partial expanded view of FIG. 1B.

As shown in FIG. 1A, the inlet end 102 of the filter 100 contains a plurality of inlet cavities 104. The inlet cavities 104 are blind, i.e., open at one end and closed at the other end. Specifically, the inlet cavities 104 are open at the inlet end 102 but closed at the opposite end of the filter 100. The filter 100 is an integral, strong, rigid, uniform porous part that has been compressed from a particulate material and sintered. Useful materials for making the filter 100 include, but are not limited to, powder metals or metal fibers such as, for example, stainless steels, nickel, tungsten, copper, and the like, and alloys, e.g., bronze, as well as ceramics. In particular embodiments, a metal powder of nickel or austenitic chromium-nickel stainless steel is used. Particularly useful metal powders are water atomized materials that include rough, irregular-shaped particles, which interlock to form an inherently strong, rigid structure upon compaction. In at least some instances, the metal powder is sieved to a specific particle size distribution, or a blend of mesh sizes is selected, in order to yield a desired level of retention/filtration in the product filter. In certain embodiments, U.S. Standard Sieves are used to control the powder size distribution, which correlates to a final particle size retention rating.

In some instances, powder metal with a mesh size (U.S. Standard Sieve) in the range of about 12 to about 500 is used. Non-limiting examples of useful mesh sizes include 30/45 mesh, 50/100 mesh, and blends thereof. The level of particulate retention of the final filter product is measured, for example, as a micron rating using a bubble point test (e.g., ASTM E128-61). In particular embodiments, metal powder is blended by mesh size to yield a final bubble point retention size micron rating between about 0.1 μm and about 150 μm. The filter retention size is sometimes referred to as a “nominal filtration rating.” A filter retains particles with a diameter at or greater than its nominal filtration rating. In some embodiments, a filter is designed to have a nominal filtration rating that corresponds to a specific polymer grade being filtered. In particular embodiments, the filter has a nominal filtration rating between about 5 μm and about 110 μm, for example, about 10 μm, about 40 μm, about 60 μm, or about 100 μm.

In some alternative embodiments, a filter is provided for use in gas filtration applications. For at least some such applications, the filter has a nominal filtration rating less than about 5 μm, for example, as low as about 0.1 μm. Such a filter is made, for example, using a metal powder having a particle size (diameter) of about 1 μm or greater. In particular embodiments, a filter is provided with a particle filtration efficiency in gas applications of at least about 90% for particles having a diameter greater than about 0.1 μm (i.e., the filter captures at least about 90% of particles having a diameter greater than about 0.1 μm). In some instances, the filter has a particle filtration efficiency in gas applications of at least about 90% for particles having a diameter greater than about 1 μm, greater than about 5 μm, greater than about 10 μm, or greater than about 20 μm.

The filter 100 is a multi-cavity single element that reduces the costs and inefficiencies associated with some earlier extended area filters designs, such as an assembly of cups in an adapter. Besides requiring more labor for the combination of additional parts, such cup assemblies are often subject to leakage between the cups, and/or bending or fracturing of the cups during filtration. In contrast, the filter 100 is an efficient one-piece integral structure that is capable of handling operating pressures (e.g., 5000 psi) for various polymer melt spinning applications. Unlike many earlier extended area filters, the filter 100 does not require a support structure, such as a breaker plate and screens, to keep it from collapsing under operating pressures. The inherent structural rigidity of the filter 100 provides for improved filter integrity, leading to increased filter life. Furthermore, the strong sintered porous metal structure of the filter 100 allows for its inter-cavity walls to be less thick than those of many previous extended area filters. The thick wall construction of previous filters generally corresponds to longer cavities, which adversely affect flow rate and throughput. For example, some earlier extended area filters require a minimum wall thickness (distance between cavities) of approximately 0.09″ for structural integrity during operation. In contrast, in at least some embodiments, the filter 100 has structural integrity with walls only about half that thickness. The ability to decrease the distance between cavities advantageously allows for a filter 100 having, for example, more than twice the filtration surface area compared to a typical extended area filter of the same envelope size that includes an assembly of cups.

Another structural advantage of the filter 100 is that its shape promotes uniform density in the final pressed part, thus allowing for more uniform flow, which results in a lower pressure drop across the filter and longer filtration life. A filter having uniform density is also desirable because practically the entire length of each filtration cavity provides useful filtration area. This is particularly beneficial compared to standard extended area filters having elongated tubular cavities, which are often subject to density distortions caused during pressing. Because the cavities in such filters are often much longer than they are wide, pressing to shape the part generally creates die wall friction, leading to non-uniform filter density. In some cases, the pores at the ends of the filter cavities are nearly blocked, such that only about half of the surface area of the cavities is useful for filtration. In particular embodiments, the filter 100 is die compacted to a length to diameter ratio of approximately 3:1 or less, for example, approximately 1:1 or less. The die wall friction during compaction is greatly reduced for diameter to length ratios in this range, thus allowing for creation of a more uniformly dense part with improved flow, and useful filtration area extending along virtually the entire length of each cavity. By way of comparison, in one embodiment, the filter 100 is about 50 mm in diameter x about 40 mm long. This filter 100 provides about twice the flow rate of a traditional cup assembly extended area filter, which has up to about 37 filter cups with approximately twice the length and surface area of the filter 100.

Thus, as illustrated in FIG. 1, some useful filters as described herein are cylindrical. In particular embodiments, a cylindrical filter 100 is provided with a length between about 20 mm and about 50 mm, and a diameter of between about 30 mm and about 70 mm. In specific embodiments, the filter 100 has a length between about 30 mm and about 40 mm, and a diameter of about 50 mm. In certain embodiments, a filter 100 is provided with a diameter raging from about 25 mm to about 150 mm and a length of up to about two times the diameter. In alternative embodiments, filters are provided in various different shapes and sizes. For example, filters are provided to fit into spinnerette head assemblies with filter housings having a variety of different configurations. By way of non-limiting example, in addition to cylindrical filters, filters in the form of square or rectangular solids, and kidney-shaped filters are contemplated.

FIG. 1B shows a cross-sectional view of the filter 100 secured in a spinnerette head assembly by an adapter ring 106. In various alternative embodiments, the filter 100 is installed (e.g., pressed-fit or adapted) in any of a variety of spinnerette head filter housings. The arrows in FIG. 1B (partial expanded view shown in FIG. 1D) indicate how material (e.g., polymer melt) to be filtered flows through the filter 100. As indicated by the arrows, external flow enters the inlet end 102 of the filter 100 through the inlet cavities 104 and the filter body 108. Advantageously, configuring the filter 100 as shown in FIG. 1B provides additional filtration area by allowing external flow to enter through the side walls 110 of the filter 100 as well. The material to be filtered then flows internally through the filter 100 until it passes through the filter body 108 or one of the blind outlet cavities 112 to exit the outlet end 114 of the filter 100.

As shown in FIG. 1C, the outlet end 114 of the filter 100 has outlet cavities 112 that are open at the outlet end 114 and closed at the opposite end of the filter 100. A comparison of FIGS. 1A and 1C indicates that, in the embodiment illustrated in FIG. 1, an interlocking pattern of equally spaced blind cavities is formed by the inlet cavities 104 and the outlet cavities 112 of the filter 100. In the illustrated embodiment, the thirteen inlet and eighteen outlet cavities 104, 112 are cylindrical, are all approximately the same size (e.g., about 5 mm in diameter), and are equally spaced in opposing directions with uniform parallel wall spacings (e.g., wall thickness between and around cavities of about 0.03″ to about 0.125″). Controlling the wall thickness (e.g., to within about ±0.005″) promotes uniform density throughout the filter. A filter arrangement as illustrated in FIG. 1 provides uniform flow throughout the filter. Further, such an arrangement allows for the filter 100 to be used in either flow direction, although flow in the direction illustrated in FIG. 1 makes better use of the available filtration surface area. Alternatively, cavities having various different sizes and/or spacings are used. For example, in certain instances tapered (e.g., conical) cavities or non-circular cavities are used. In specific embodiments, flat-sided, e.g., triangular or box-shaped, cavities are employed to increase the uniform cross-sectional area between cavities and increase the effective filtration surface area. In particular embodiments, cavities of the desired shape are die pressed in opposing directions, in some instances with parallel tolerances to within about 0.001″ of each other. In at least some embodiments, the size of the cavities is large enough to allow for batch cleaning of the filter in a salt bath batch cleaning operation.

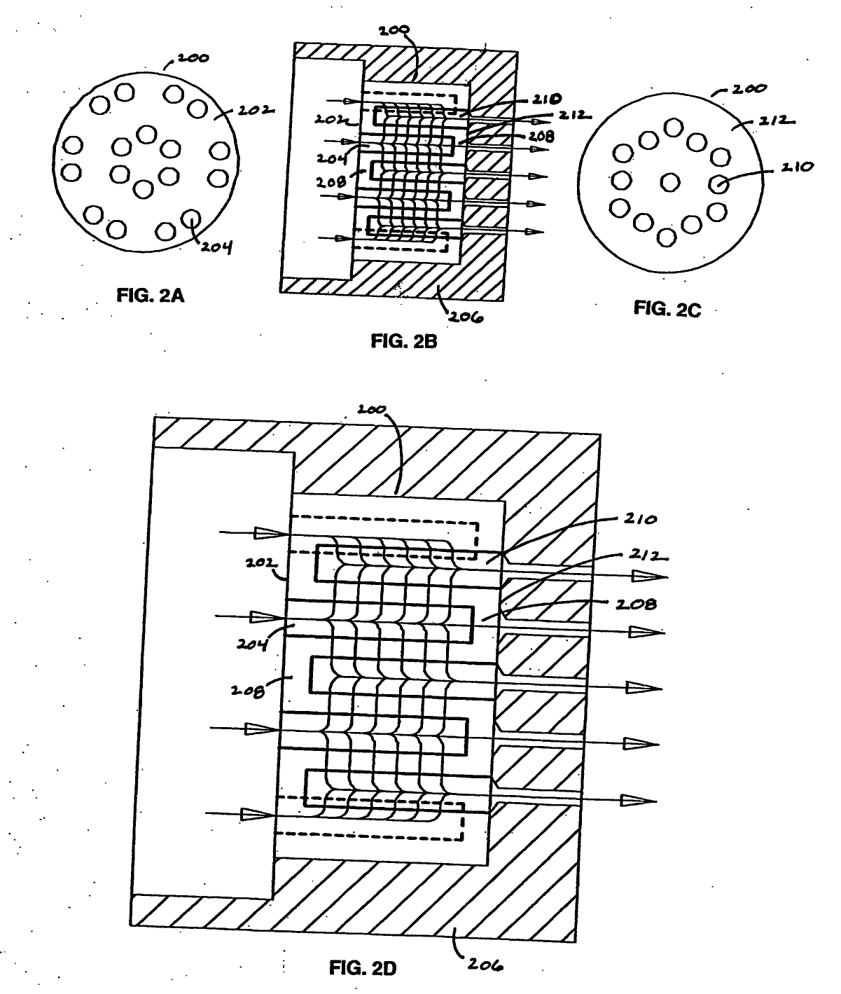

FIGS. 2A-D illustrate a filter 200 according to certain embodiments of the invention. FIG. 2A is a top view of the inlet end 202 of the filter 200. FIG. 2B is a cross-sectional view of the filter 200 inserted in a media cup 206 from a spinnerette head assembly. FIG. 2C is a top view of the outlet end 212 of the filter 200. FIG. 2D is an expanded view of FIG. 2B.

As shown in FIG. 2A, the inlet end 202 of the filter 200 has blind inlet cavities 204 that are open at the inlet end 202 and closed at the opposite end of the filter 200. In the illustrated embodiment, eighteen inlet cavities 204 are employed. However, as described above, one of skill in the art will appreciate that the size, shape, number, and arrangement of cavities is varied as desired for a given application.

FIG. 2B is a cross-sectional view of the filter 200 fit into a media cup 206 from a spinnerette head assembly. In the illustrated embodiment, the filter 200 is pressed (interference fit) into the media cup 206, forming a seal. No adapter is required to fit the filter 200 into the media cup 206, thus simplifying the assembly. Such a filtration assembly advantageously eliminates the loose fill media that is traditionally used in media cups. Loose fill media is associated with problems such as channeling, media migration, and separation during use. The arrows in FIG. 2B indicate the flow of material to be filtered, with an expanded view shown in FIG. 2D. External flow enters the inlet end 202 of the filter 200 through the inlet cavities 204 and the filter body 208. The material to be filtered then flows internally through the filter 200 until it passes through the filter body 208 or one of the outlet cavities 210 to exit the outlet end 212 of the filter 200. The filter 200 is suitable for use in either flow direction, but the flow direction illustrated in FIG. 2 provides better use of the available filtration surface area. In some embodiments, the filter 200 is made with additional inlet cavities 204 because polymer melt does not enter through the side walls of the filter 200 housed within the media cup 206 as it does through the side walls 110 of the filter 100 mounted as illustrated in FIG. 1B.

As shown in FIG. 2C, the outlet end 212 of the filter 200 has blind outlet cavities 210 that are open at the outlet end 212 and closed at the opposite end of the filter 200. In the illustrated embodiment, thirteen outlet cavities 210 are employed. However, as described above, one of skill in the art will appreciate that the size, shape, number, and arrangement of cavities is varied as desired for a given application.

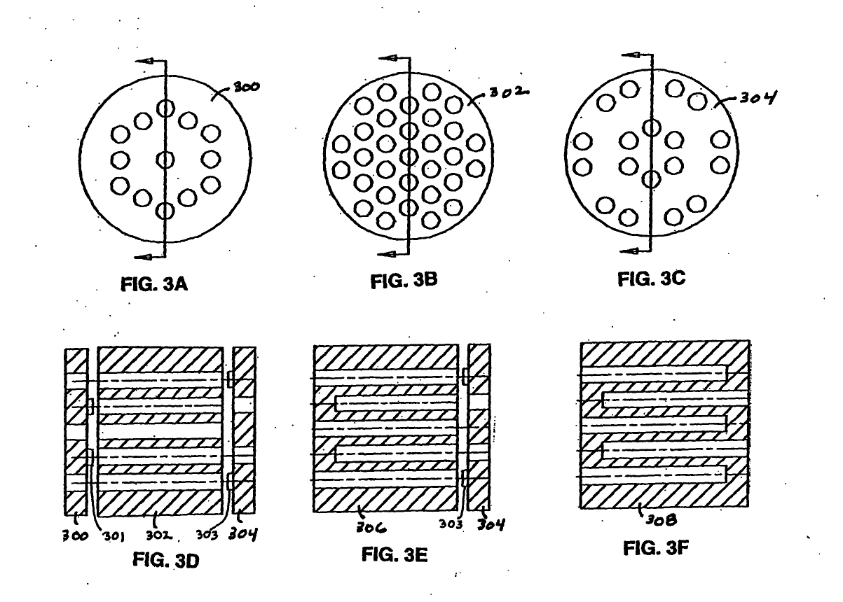

FIGS. 3A-C are top views of, respectively, the top cap 300, filter body 302, and bottom cap 304 of a filter according to certain embodiments of the invention. FIGS. 3D-F are cross-sectional views illustrating three possible methods of making a filter with parts as illustrated in FIGS. 3A-C.

FIG. 3D shows a top cap 300, filter body 302, and bottom cap 304 that, when assembled, create a filter. In the illustrated embodiment, the top cap 300 and bottom cap 304 have protrusions 301, 303 that facilitate alignment and assembly of the parts 300, 302, 304 to form a filter. In alternative embodiments, such protrusions are not included and the filter parts are aligned and assembled using other means, for example, an alignment pin. In certain embodiments, the three parts 300, 302, 304 are die pressed separately, the green (i.e., unsintered) parts are assembled and pressed together in a secondary pressing operation, and the resulting green filter is sintered. In some alternative embodiments, as illustrated in FIG. 3E, one end cap (the top cap in the illustrated embodiment) and the filter body are die pressed together as a single part 306, and the other end cap (the bottom cap 304 in the illustrated embodiment) is prepared separately. The two parts 304, 306 are then assembled, pressed together into a single component, and sintered. As shown in the illustrated embodiment, the bottom cap 304 optionally includes protrusions 303 that facilitate alignment and assembly of the parts 304, 306. In still other embodiments, as shown in FIG. 3F, a filter is made as a single part 308, e.g., using isostatic pressing, metal injection molding, or split die techniques, and then sintered. In some embodiments of the above-described die pressing methods, an open die with moving punches is used, allowing for adjustments to length (filter thickness) during production. This is an advantage over previous filter manufacturing processes, which often employ fixed cavity molds that are not able to be adjusted for length or provide in-process variations.

In certain embodiments, a sintered powder metal filter is prepared by feeding a controlled volume of blended water atomized metal powder to a die through a feed shoe. The powder is directly pressed in the die into a finished green part ready for assembly and/or sintering. The powder is pressed in a mold having the desired shape of the final filter or a sub-part thereof. Thus, the pressed green part has the desired shape, and machining is not required, e.g., to form or refine inlet and outlet cavities in the filter body. The metal feed stock does not change in consistency during the pressing cycle, allowing for a tightly controlled pore size distribution in the green compact. Compacting the water atomized metal particulate under pressure causes the irregular-shaped metal granules to interlock. This interlocking structure provides for a part that has good green strength and controlled permeability without the use of a binder such as the polymer materials typically used in porous filter production.

The ability to form a green part of sufficient strength without using a polymeric binder is advantageous because it eliminates the residual contaminants that are often left behind in the final filter product when the binder is burned off. Thus, unlike many previous extended area filters, the filter produced as described herein is substantially free from polymer binder decomposition products, e.g., residual carbon, which adversely affect the corrosion resistance and surface chemistry of the filter. Producing a filter without using a binder also avoids other problems. For example, traditional filter production methods employing a binder often begin by mixing a metal powder/binder dispersion. The use of such a dispersion can adversely affect the retention rating of the final product, e.g., due to non-uniformity of the dispersion or shear and damage to the metal particulate during mixing. Another advantage of production without a binder is that a dry blend of metal powder, unlike a metal/binder dispersion, has no shelf-life.

The above-described filter production method is also beneficial because the metal powder is directly pressed into the desired filter (or sub-part) shape, such that no additional machining is required, e.g., to form the filtration cavities. Eliminating secondary machining steps avoids the structural distortions, such as compacting, smeared pores, and surface blinding, that often are caused by traditional drilling and turning processes. The substantially uniform pore structure of a filter without such distortions provides improved flow rate and more uniform flow, leading to better throughput and increased filtration life.

Moreover, by eliminating one or more of the binder-associated processes and secondary machining steps used in many known methods for filter production, the above-described process allows for more streamlined, economic filter manufacture. For example, in at least some embodiments, the methods described herein allow for the elimination of the following steps employed in many common porous filter production methods: mixing a metal/binder slurry, forming a blank slug of metal/binder by heating and cooling in a die, curing the metal/binder resin (e.g., for about 30 hours), machining filter surfaces and/or cavities, burning off the binder (e.g., for about 7 hours), and performing quality control checks for residual carbon left in the filter after binder burn-off. Thus, the methods described herein provide for enhanced efficiency and reduced cost of filter production.

Once the green filter part or assembly has been formed as described above, it is sintered, for example, in an atmosphere of hydrogen or a blend of hydrogen and nitrogen (e.g. 87.5% hydrogen/12.5% nitrogen). In at least some embodiments, the sintering atmosphere has a dew point at or below 40° F. One of skill in the art will appreciate that the specific sintering conditions, including atmosphere, temperature, and duration of sintering, are chosen according to the particular application based on known sintering techniques. Typical sintering temperatures for powder metals range, for example, between about 1800° F. and about 3000° F., with sintering times between about 20 minutes and about 2 hours. In particular embodiments, a part made from austenitic chromium-nickel stainless steel or nickel powder is sintered at between about 2400° F. and about 2480° F. for between about 20 minutes and about 2 hours. Higher sintering temperatures often are used for ceramic materials, for example, at least about 3500° F.

The following non-limiting examples further illustrate particular embodiments of the invention:

### EXAMPLE 1

An extended area filter was produced as illustrated in FIG. 3D. Dies were configured to produce the three discrete cavity patterns for the top cap, filter body, and bottom cap. The powder metal tooling consisted of a carbide die, an upper punch, a lower punch, and core rods. The tools were adapted to a hydraulic die-set powder metal press. The following charge weights of 50/100 mesh blend of nickel powder were placed in the dies: 35 g for each of the top and bottom caps, and 185 g for the filter body. The parts were compacted to approximately 4000 psi, and then ejected from the dies. The parts were assembled, utilizing the alignment features molded into the top and bottom end caps, and pressed together at approximately 2000 psi. The resulting one-piece filter part was then sintered at approximately 2400° F. in a hydrogen atmosphere with a dew point less than 40° F. for 1½ hours.

The finished filter was approximately 50 mm in diameter x 30 mm tall. The filter had 13 filter cavities, each 5 mm in diameter x 30 mm long. When oriented as illustrated in FIG. 1B, the cavity walls combined with the exposed filter body surface increased the effective filter surface area by approximately 4.5 times compared to a typical 50 mm porous disc filter. A bubble point measurement on the filter resulted in an absolute micron rating of approximately 15 μm.

For testing purposes, the sintered filter was pressed fit into a 60 mm adapter ring in a spinnerette assembly, replacing a previously used multi-element filter. The new filter operated at hydrostatic pressures of 1500 psi to 4000 psi, showing little sign of deflection.

### EXAMPLE 2

An extended area filter was produced from an austenitic chromium-nickel stainless steel powder blend as illustrated in FIG. 3D, using similar procedures to those described in Example 1. The parts were pressed from a blend of 30/45 mesh powder in the following weights: 25 g for each of the top and bottom caps, and 172 g for the filter body. The part was then sintered at approximately 2450° F. in an atmosphere of 87.5% hydrogen and 12.5% nitrogen, with a dew point less than 40° F. for 11/2 hours.

The finished filter was approximately 50 mm in diameter x 30 mm tall. The filter had 18 filter cavities, each 5 mm in diameter x 30 mm long. This design added approximately 3.5 times the effective filter surface area and provided about twice the flow rate compared to a typical sintered metal extended area filter assembly (31 cups pressed into a plate) of the same height and diameter. A bubble point measurement on the filter resulted in an absolute micron rating of approximately 40 μm.

The filter was pressed fit, with approximately 0.015″ interference, into a standard 50 mm Barmag media cup (Barmag AG, Remscheid, Germany) using no more than 1400 psi force to insert it. This application eliminates loose fill media in the spinnerette head filter, and thus eliminates problems associated with the use of loose fill media, such as channeling, media migration, separation, and leaking seals.

It will be appreciated that the scope of the present invention is not limited to the above-described embodiments, but rather is defined by the appended claims, and that these claims will encompass modifications of and improvements to what has been described.

1. An integral porous filter formed of a fixed media, the media being formed to have substantially uniform pore structure and density and being substantially free from polymer binder decomposition products,
the filter having an inlet end defining a plurality of inlet openings and an outlet end defining a plurality of outlet openings,
the filter defining a plurality of blind inlet cavities extending into the filter from the inlet openings in the inlet end, and a plurality of blind outlet cavities extending into the filter from the outlet openings in the outlet end, each inlet and outlet cavity defining a fluid communication path and being closed at one end,
wherein the inlet and outlet cavities are arranged so that fluid entering an inlet cavity flows into the inlet cavity and through a wall defining the cavity into an adjacent outlet cavity.

2. The filter of claim 1, wherein the filter is formed from compressed, sintered powder metal.

3. The filter of claim 2, wherein the powder metal has a particle size of about 1 μm or greater.

4. The filter of claim 2, wherein the powder metal has a U.S. Standard Sieve mesh size between about 12 and about 500.

5. The filter of claim 4, wherein the powder metal has a mesh size selected from the group consisting of 30/45 mesh, 50/100 mesh, and blends thereof.

6. The filter of claim 2, wherein the powder metal is selected from the group consisting of stainless steel, nickel, tungsten, copper, bronze, and combinations thereof.

7. The filter of claim 6, wherein the powder metal includes nickel.

8. The filter of claim 6, wherein the powder metal includes austenitic chromium-nickel stainless steel.

9. The filter of claim 2, wherein the powder metal is water atomized.

10. The filter of claim 1, wherein the filter has a nominal filtration rating between about 5 μm and about 110 μm.

11. The filter of claim 10, wherein the filter has a nominal filtration rating of about 10 μm.

12. The filter of claim 10, wherein the filter has a nominal filtration rating of about 40 μm.

13. The filter of claim 10, wherein the filter has a nominal filtration rating of about 60 μm.

14. The filter of claim 10, wherein the filter has a nominal filtration rating of about 100 μm.

15. The filter of claim 1, wherein the filter has a nominal filtration rating between about 0.1 μm and about 5 μm.

16. The filter of claim 1, wherein the filter has a particle filtration efficiency in gas applications of at least about 90% for particles having a diameter greater than about 0.1 μm.

17. The filter of claim 1, wherein the filter is approximately cylindrical in shape and has a length to diameter ratio of about 3:1 or less.

18. The filter of claim 17, wherein the length to diameter ratio is about 1:1 or less.

19. The filter of claim 17, wherein the filter has a length between about 20 mm and about 50 mm, and a diameter of between about 30 mm and about 70 mm.

20. The filter of claim 19, wherein the filter has a length between about 30 mm and about 40 mm, and a diameter of about 50 mm.

21. The filter of claim 1, wherein the filter defines cylindrical inlet cavities and outlet cavities having substantially uniform diameter and substantially uniform wall thickness between cavities.

22. A polymer melt spin pack assembly comprising a spinnerette head having a filter housing and an integral porous filter disposed within the filter housing,
the filter being formed of a fixed media, the media being formed to have substantially uniform pore structure and density and being substantially free from polymer binder decomposition products,
the filter having an inlet end defining a plurality of inlet openings and an outlet end defining a plurality of outlet openings,
the filter defining a plurality of blind inlet cavities extending into the filter from the inlet openings in the inlet end, and a plurality of blind outlet cavities extending into the filter from the outlet openings in the outlet end, each inlet and outlet cavity defining a fluid communication path and being closed at one end,
wherein the inlet and outlet cavities are arranged so that fluid entering an inlet cavity flows into the inlet cavity and through a wall defining the cavity into an adjacent outlet cavity.

23. The assembly of claim 22, wherein the spinnerette head has an adapter ring for sealing the filter within the filter housing.

24. The assembly of claim 22, wherein the filter is sealed within the filter housing by an interference fit.

25. The assembly of claim 22, wherein the filter is formed from compressed, sintered powder metal.

26. The assembly of claim 25, wherein the powder metal has a U.S. Standard Sieve mesh size between about 12 and about 500.

27. The assembly of claim 26, wherein the powder metal has a mesh size selected from the group consisting of 30/45 mesh, 50/100 mesh, and blends thereof.

28. The assembly of claim 25, wherein the powder metal is selected from the group consisting of stainless steel, nickel, tungsten, copper, bronze, and combinations thereof.

29. The assembly of claim 28, wherein the powder metal includes nickel.

30. The assembly of claim 28, wherein the powder metal includes austenitic chromium-nickel stainless steel.

31. The assembly of claim 25, wherein the powder metal is water atomized.

32. The assembly of claim 22, wherein the filter has a nominal filtration rating between about 5 μm and about 110 μm.

33. The assembly of claim 32, wherein the filter has a nominal filtration rating of about 10 μm.

34. The assembly of claim 32, wherein the filter has a nominal filtration rating of about 40 μm.

35. The assembly of claim 32, wherein the filter has a nominal filtration rating of about 60 μm.

36. The assembly of claim 32, wherein the filter has a nominal filtration rating of about 100 μm.

37. The assembly of claim 22, wherein the filter is approximately cylindrical in shape and has a length to diameter ratio of about 3:1 or less.

38. The assembly of claim 37, wherein the length to diameter ratio is about 1:1 or less.

39. The assembly of claim 37, wherein the filter has a length between about 20 mm and about 50 mm, and a diameter of between about 30 mm and about 70 mm.

40. The assembly of claim 39, wherein the filter has a length between about 30 mm and about 40 mm, and a diameter of about 50 mm.

41. The assembly of claim 22, wherein the filter defines cylindrical inlet cavities and outlet cavities having substantially uniform diameter and substantially uniform wall thickness between cavities.

42. A method of filtering a polymer melt for extrusion, the method comprising:
(a) providing a polymer melt spin pack assembly comprising a spinnerette head including a spinnerette, a filter housing, and an integral porous filter disposed within the filter housing,
the filter being formed of a fixed media, the media being formed to have substantially uniform pore structure and density and being substantially free from polymer binder decomposition products,
the filter having a side wall, an inlet end defining a plurality of inlet openings, and an outlet end defining a plurality of outlet openings,
the filter defining a plurality of blind inlet cavities extending into the filter from the inlet openings in the inlet end, and a plurality of blind outlet cavities extending into the filter from the outlet openings in the outlet end, each inlet and outlet cavity defining a fluid communication path and being closed at one end,
wherein the inlet and outlet cavities are arranged so that fluid entering an inlet cavity flows into the inlet cavity and through a wall defining the cavity into an adjacent outlet cavity;
(b) introducing a polymer melt into the filter through the inlet end and optionally the side wall of the filter;
(c) flowing the polymer melt through the inlet cavities, walls defining the cavities, and outlet cavities of the filter, whereby filtered polymer melt flows out of the outlet end of the filter; and
(d) extruding the filtered polymer melt through the spinnerette.

43. The method of claim 42, further comprising sealing the filter within the filter housing.

44. The method of claim 43, wherein the filter is sealed within the filter housing using an adapter ring.

45. The method of claim 43, wherein the filter is sealed within the filter housing by an interference fit.

46. The method of claim 42, wherein the filter is formed from compressed, sintered powder metal.

47. The method of claim 42, wherein the filter has a nominal filtration rating between about 5 μm and about 10 μm.

48. The method of claim 42, wherein the filter is approximately cylindrical in shape and has a length to diameter ratio of about 3:1 or less.

49. The method of claim 42, wherein the filter defines cylindrical inlet cavities and outlet cavities having substantially uniform diameter and substantially uniform wall thickness between cavities.
